(19) United States
(12) Patent Application Publication
(10) Pub. No.: US 2011/0094768 A1
(43) Pub. Date: Apr. 28, 2011

(54) IMPLANTABLE MEDICAL DEVICE HAVING FEEDTHRU WITH AN INTEGRATED INTERCONNECT/FILTER SUBSTRATE

(75) Inventors: Dion F. Davis, Acton, CA (US); Zeev Lavine, Ventura, CA (US); Alvin Weinberg, Moorpark, CA (US)

(73) Assignee: PACESETTER, INC., Sylmar, CA (US)

(21) Appl. No.: 12/607,893

(22) Filed: Oct. 28, 2009

(51) Int. Cl. H01R 13/46; H02G 3/18

(52) U.S. Cl. 174/59; 174/650

(57) ABSTRACT

Disclosed herein is an implantable pulse generator. The implantable pulse generator includes a header, a can, a feedthru, a feedthru substrate and a conductor. The header includes a lead connector block. The can is coupled to the header and includes a wall and an electronic substrate housed within the wall. The feedthru is mounted in the wall and includes a header side, a can side and a feedthru wire extending through the feedthru and having a first end and a second end opposite the first end. The first end is electrically coupled to the lead connector block. The feedthru substrate is adjacent the can side and includes capacitance layers, an electrically conductive input layer, and an electrically conductive input surface defined on a surface of the feedthru substrate and electrically coupled to the input layer. The input layer is electrically coupled to the second end. The conductor electrically couples the input surface and the electronic substrate. The conductor may be in the form of a wire bond. The input surface may include input pads oriented to match complementary electrical connection locations or pads of the electronic substrate, and the wire bonds may extend between the input pads and the complementary electrical connection locations or pads of the electronic substrate.

### FIELD OF THE INVENTION

The present invention relates to medical apparatus and methods. More specifically, the present invention relates to feedthrus for implantable pulse generators and methods of manufacturing such feedthrus.

### BACKGROUND OF THE INVENTION

Implantable pulse generators, including cardiovascular implantable electronic devices (“CIED”) such as pacemakers and implantable cardioverter defibrillators (“ICD”), are used to provide therapy to cardiac tissue, nerves and other tissue via implantable leads. An implantable pulse generator feedthru is used for an electrical pathway extending between the electrically conductive lead securing components of a header of the pulse generator and the electrical components, such as an output flex, hybrid, etc., hermetically sealed in the housing or can of the pulse generator.

Feedthrus provide insulated passageways for feedthru wires, such as platinum iridium (Pt/Ir) wires, through the wall of the can. The header ends of the feedthru wires are electrically connected to connector blocks that mechanically and electrically couple with proximal connectors ends of implantable leads, and the can ends of the feedthru wires are electrically connected to the electrical components housed in the can of the pulse generator.

Current feedthrus employ discoidal filter assemblies for filtering out unwanted signals, such as those associated with electro-magnetic interference (“EMI”). There are a number of disadvantages associated with employing discoidal filters. For example, discoidal filter assemblies have high associated material and manufacturing costs. Discoidal filters also require substantial space and do not facilitate automated manufacturing processes for coupling the feedthru wires to the electronic components housed in the can.

There is a need in the art for an EMI filtered feedthru that has reduced material and manufacturing costs. Also, there is a need in the art for a method of manufacturing such a feedthru.

### BRIEF SUMMARY OF THE INVENTION

Disclosed herein is an implantable pulse generator. In one embodiment, the implantable pulse generator includes a header, a can, a feedthru, a feedthru substrate and a conductor. The header includes a lead connector block. The can is coupled to the header and includes a wall and an electronic substrate housed within the wall. The feedthru is mounted in the wall and includes a header side, a can side and a feedthru wire extending through the feedthru and having a first end and a second end opposite the first end. The first end is electrically coupled to the lead connector block. The feedthru substrate is adjacent the can side and includes capacitance layers, an electrically conductive input layer, and an electrically conductive input surface defined on a surface of the feedthru substrate and electrically coupled to the input layer. The input layer is electrically coupled to the second end. The conductor electrically couples the input surface and the electronic substrate. In one version of the embodiment, the conductor is in the form of a wire bond. In another version of the embodiment, the input surface includes input pads oriented to match complementary electrical connection locations or pads of the electronic substrate, and wire bonds extend between the input pads and the complementary electrical connection locations or pads of the electronic substrate.

Disclosed herein is another implantable pulse generator. In one embodiment, the pulse generator includes a can, a header, at least one electronic substrate, a feedthru, and a feedthru substrate. The can includes a wall. The header is coupled to the can and includes at least one lead connector block. The at least one electronic substrate is housed within the wall and electrically coupled to an electrical conductor. The feedthru is mounted in the wall and includes a header side, a can side, and at least one feedthru wire extending through the feedthru. Each of the at least one feedthru wire includes a header end and a can end. The header end is electrically coupled to the at least one lead connector block. The feedthru substrate is adjacent the can side. The feedthru substrate provides capacitance means for providing capacitance for the at least one feedthru wire and conductive means for electrically coupling the at least one feedthru wire to the electrical conductor. In one version of the embodiment, the conductor is in the form of a wire bond.

Disclosed herein is a feedthru assembly for being mounted in a can wall of an implantable pulse generator having a can and a header. In one embodiment, the feedthru assembly includes a feedthru and a feedthru substrate. The feedthru includes a housing, an electrically insulating body, and a feedthru wire. The housing is configured to mount in the can wall and includes an opening defined in the housing. The electrical insulating body is received in the opening and includes a header side and a can side. The feedthru wire extends through the electrical insulating body from the header side to the can side. The feedthru substrate is adjacent the can side and has multiple layers. At least some of the multiple layers are electrically conductive capacitance layers, and at least one of the multiple layers is an electrically conductive input layer electrically coupled to the feedthru wire.

While multiple embodiments are disclosed, still other embodiments of the present invention will become apparent to those skilled in the art from the following Detailed Description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a side view of such an implantable pulse generator, wherein the wall of the can is partially cut away to show the components of the pulse generator enclosed in the can.

FIG. 2 is a top side isometric view of the feedthru of the feedthru assembly depicted in FIG. 1.

FIG. 3 is a side view of the feedthru.

FIG. 4 is an end view of the feedthru.

FIG. 5 is a bottom side isometric view of the feedthru.

FIG. 6 is a top side isometric view of the feedthru assembly depicted in FIG. 1, wherein the feedthru assembly includes the feedthru of FIG. 2 and an integrated interconnect/filter feedthru substrate.

FIG. 7 is a side view of the contact side of the feedthru assembly.

FIG. 8 is an end view of the feedthru assembly.

FIG. 9 is a side view of the feedthru assembly opposite the side depicted in FIG. 7.

FIG. 10 is a top plan view of the feedthru assembly.

FIG. 11 is a cross-section side view of the feedthru assembly as taken along section line 11-11 in FIG. 10.

FIG. 12 is a bottom side isometric view of the feedthru assembly.

FIG. 13 is the same view as FIG. 12, except the feedthru substrate has been exploded and moved away from the feedthru to show the various conductive, capacitive and shielding layers of the feedthru substrate.

FIG. 14 is the same view as FIG. 13, less the power trace layer and shield layer wherein the capacitance layers are less spread out in their expanded state to depict the feedthru wires extending through the layers.

### DETAILED DESCRIPTION

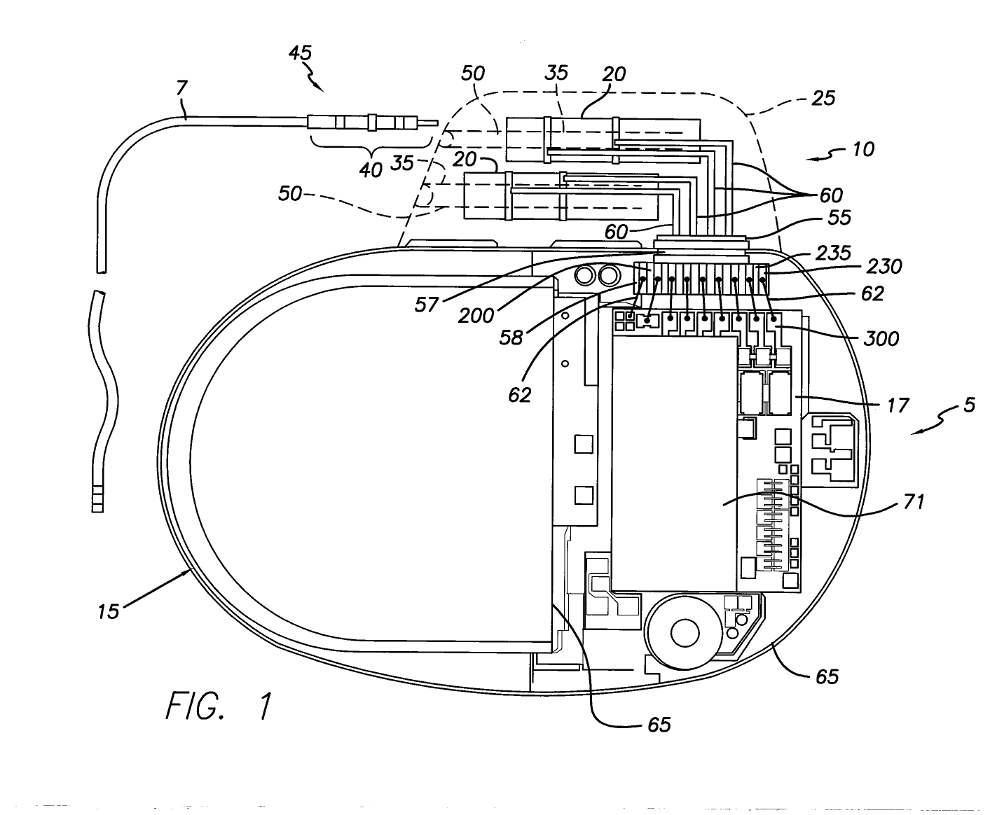

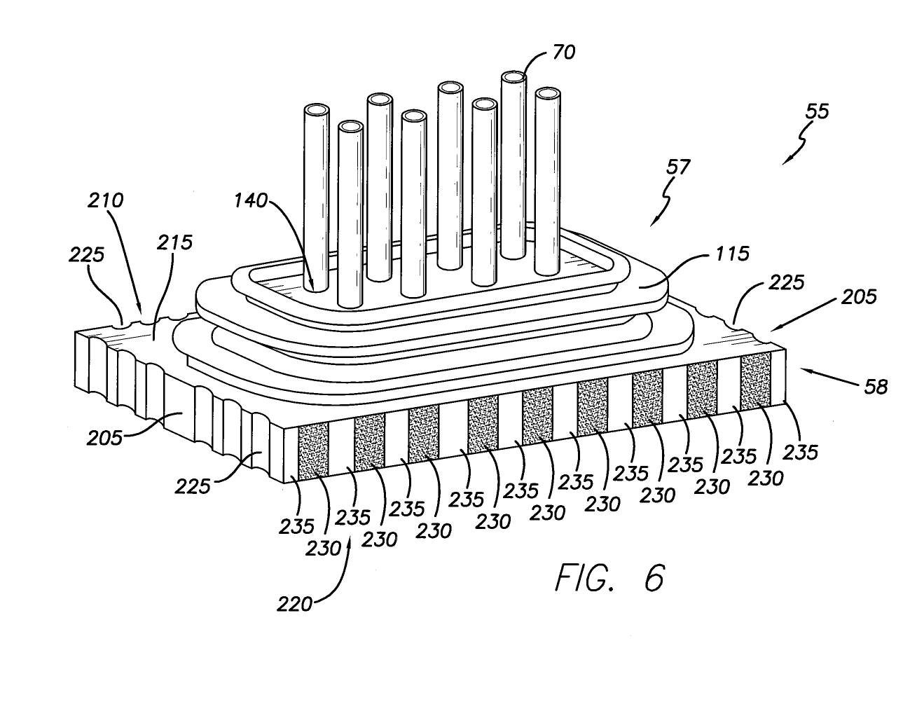

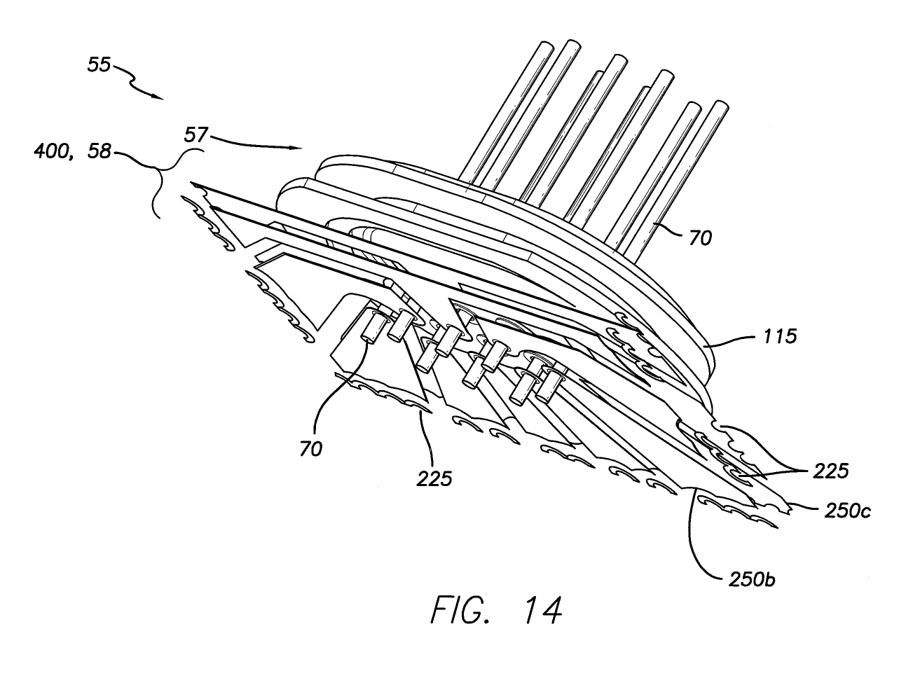

As shown in FIG. 1, the present disclosure describes a feedthru assembly 55 of an implantable pulse generator 5 such as, for example, a pacemaker or an ICD. As can be understood from FIGS. 6 and 13, in one embodiment, the feedthru assembly 55 disclosed herein is an EMI filtered feedthru assembly 55 that includes a non-EMI filtered feedthru 57 close-coupled to an integrated interconnect/filter feedthru substrate 58 having integrated filtering layers 250B-C that provide EMI filtering for the feedthru assembly 55. For example, in addition to including electrically conductive layers 250A and 250D within the integrated interconnect/filter feedthru substrate 58 for coupling the power and ground circuits of the feedthru assembly 55 to the electrically conductive pads 300 of the electronic substrate 17 that supports and electrically interconnects various electronic components 71 in the can 15, the interconnect substrate 58 also may include capacitance layers 250B-C and insulation layers 280A-C for creating an EMI filter 400 (see FIGS. 13 and 14). The resulting feedthru assembly 55 with its feedthru 57 and integrated interconnect/filter substrate 58 advantageously provides a configuration that offers reduced size and materials cost and improved ease of manufacturing, facilitating a more compact pulse generator and decreased manufacturing costs. For example, at least in part because of its configuration, the feedthru assembly 55 facilitates the use of wire bond 62 for electrically coupling the electrically conductive surfaces 230 of the input circuit of the feedthru assembly 55 to complementary electrically conductive pads 300 of the electronic substrate 17 that supports and electrically interconnects various electronic components 71 housed in the can 15.

For a general discussion of an implantable pulse generator 5 that utilizes the feedthru assembly 55 having the feedthru 57 and integrated interconnect/filter feedthru substrate 58 disclosed herein, reference is first made to FIG. 1, which is an side view of such an implantable pulse generator 5, wherein the wall 65 of the can 15 is partially cut away to show the components of the pulse generator 5 enclosed in the can 15. As indicated in FIG. 1, the pulse generator 5 includes a header 10 and a can or housing 15. The header 10 includes connector blocks 20 and a molded portion 25 (shown in phantom) that encloses the connector blocks 20. Each connector block 20 includes an opening 35 configured to receive therein and mate with a connector end 40 of a proximal end 45 of an implantable lead 7, thereby forming an electrical connection between the connector block 20 and the lead connector end 40 and mechanically securing the proximal end 45 of the lead 7 to the header 10 of the pulse generator 5.

The header molded portion 25 (shown in phantom) may be formed of a polymer material or epoxy. Passages 50 (shown in phantom) extend from the exterior of the molded portion 25 to the openings 35 in the connector blocks 20, providing a pathway for the lead distal ends 40 to pass through the molded portion 25 and enter the openings 35.

The can 15 includes one or more feedthru assemblies 55 mounted in the wall of the can 15. More specifically, the feedthru assembly 55 includes a feedthru 57 mounted in the can wall 65 and close coupled to an integrated interconnect/filter feedthru substrate 58 on a can side of the feedthru 57, thereby forming an integrated feedthru/interconnect/filter assembly 55.

Conductors 60 (e.g., round wires, flat ribbon wires, flex cables or etc.) extend from the header side of the feedthru 57 to respective connector blocks 20. The can 15 provides a hermetically sealed enclosure for the pulse generator's electronic components 71 (e.g., hybrid, or various other electronic components), which are mounted on, and electrically interconnected via, an electronic substrate 17, all of which are housed within the can 15. As discussed in greater detail below, conductors 62, which are in the form of wire bond 62, extend from a side of the integrated interconnect/filter feedthru substrate 58 to the electronic substrate 17 and, as a result, to the electronic components 71. Typically, the wall of the can 15 is made of titanium or another biocompatible metal.

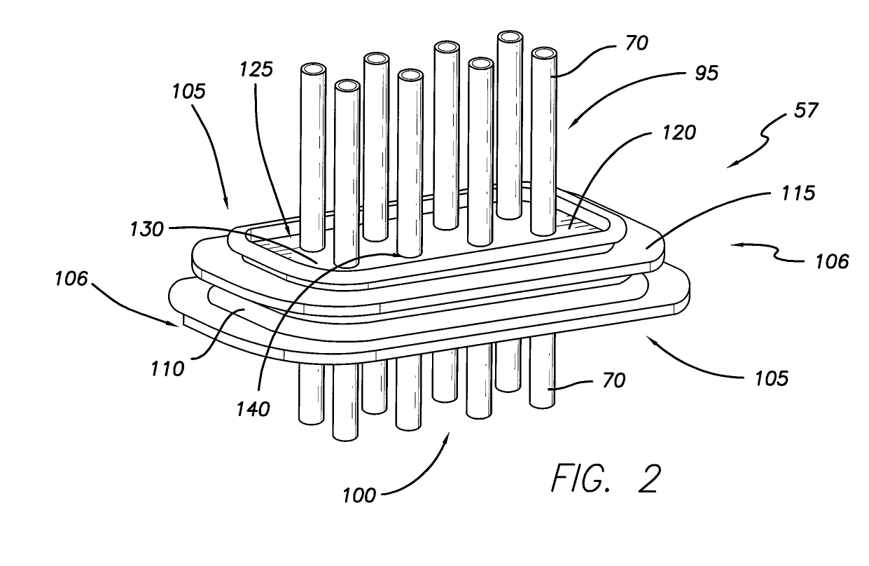

For a detailed discussion of the components of the feedthru 57, reference is now made to FIGS. 2-5. FIGS. 2-5 are, respectively, top side isometric, side, end, and bottom side isometric views of an embodiment of the feedthru 57 of feedthru assembly 55 shown in FIG. 1.

In one embodiment, as shown in FIGS. 2-5, the feedthru 57 includes a header side 95, a can side 100, opposed longitudinally extending sides 105, and opposed ends 106. While the overall shape of the feedthru 57 depicted in FIGS. 2-4 is generally rectangular, in other embodiments the overall shape of the feedthru 57 may be other shapes, including oval, square, circular, etc.

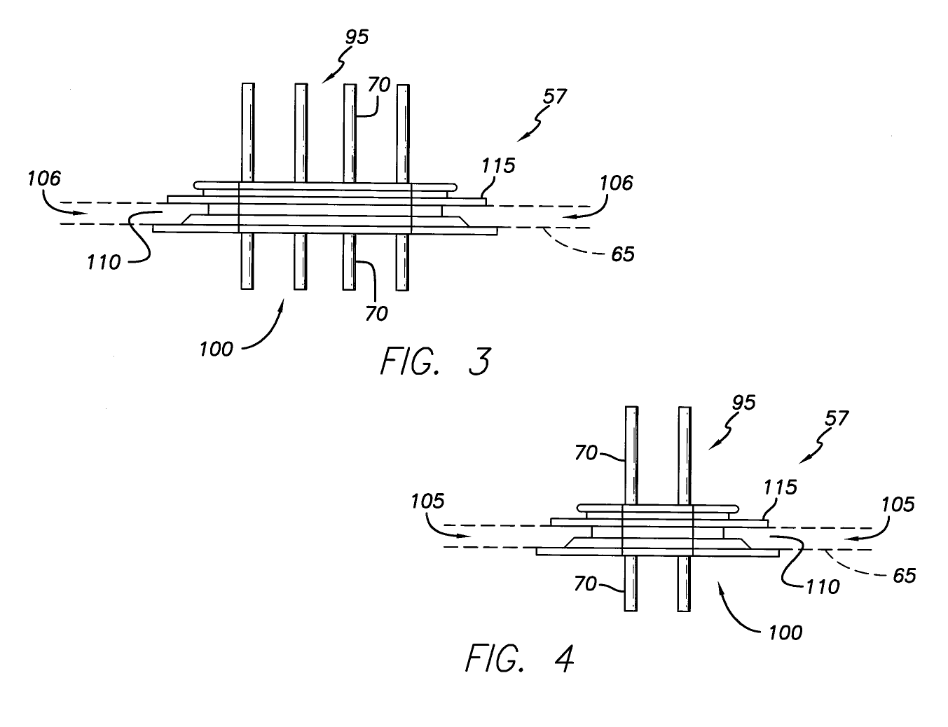

As can be understood from FIGS. 2-5, the feedthru 57 includes a feedthru housing 115, a core 120, and feedthru conductors 70, which may be in the form of solid wires or other types of conductor configurations. The feedthru housing 115 forms the sides 105 and ends 106 of the feedthru 57 and includes a central or core-receiving opening 125. The feedthru housing 115 may be machined, molded or otherwise formed to fit the space and design constraints of an implantable pulse generator 5. The feedthru housing 115 may be titanium, a titanium alloy, MP35N, or stainless steel. The sides 105 and ends 106 of the feedthru housing 115 may be configured such that a groove or slot 110 is defined therein. As can indicated in FIGS. 3 and 4, the groove or slot 110 in the feedthru housing 115 receives the can wall 65 when the feedthru 57 is mounted in the can wall 65 as shown in FIG. 1.

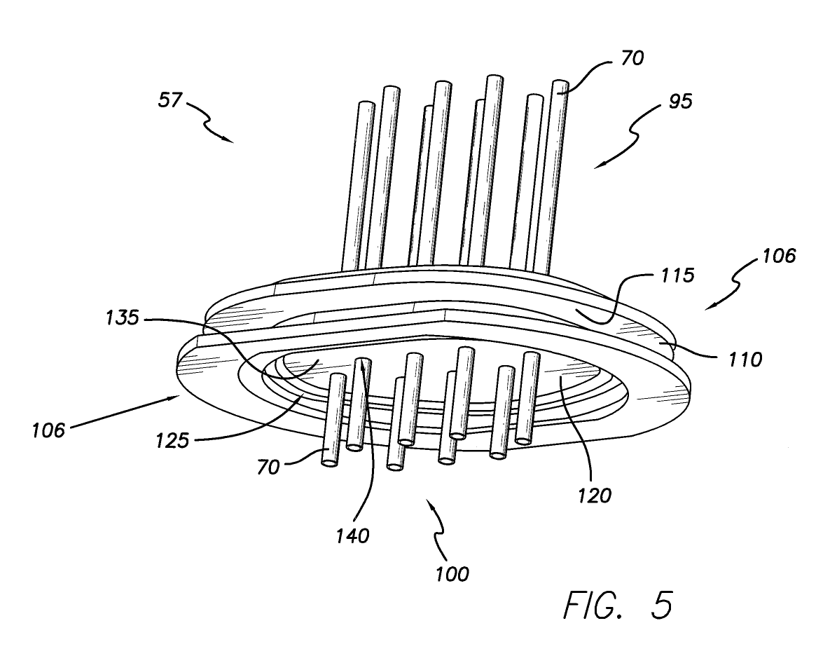

As can be understood from FIGS. 2 and 5, the central opening 125 of the feedthru housing 115 extends axially through the feedthru housing and defines a void that is occupied by the core 120. The core 120 includes a header face 130, a can face 135, and through-holes 140 extending axially therethrough. The feedthru wires 70 extend through the core 120 via the through-holes 140. The core 120 may be formed of an electrically insulating material, such as ceramic, glass, or sapphire.

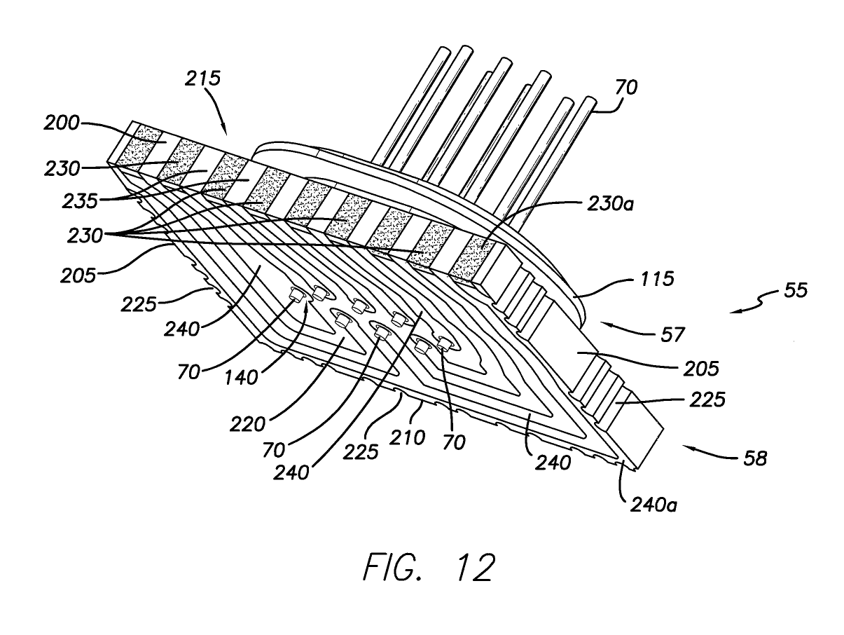

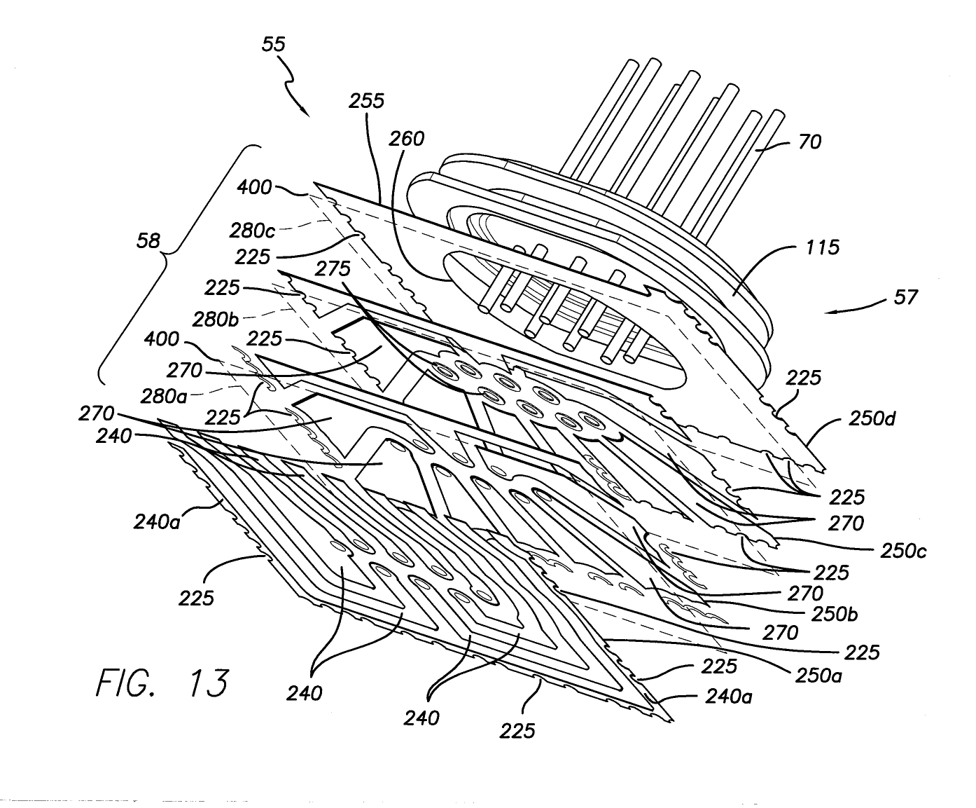

As indicated in FIGS. 2-4, there may be up to eight feedthru wires 70 extending through the core 120 in two rows of four wires 70. In other embodiments, as can be understood from FIGS. 12-13 discussed below, the eight wires 70 may be arranged in two rows of three wires 70 with a single extra wire 70 between centered between the rows at the ends of the rows. In other embodiments, the wires 70 may be of a greater or lesser number and configured in other arrangements.

The feedthru wires 70 may be made of gold, platinum, nickel, titanium, or MP35N. To assemble the feedthru 57, the feedthru housing 115 and core 120 may be connected by soldering, brazing, welding or other suitable method to form a feedthru housing-core assembly. The coupling of the core 120 to the feedthru housing 115 creates a hermetic seal. The feedthru wires 70 may be connected to the holes 140 of the core 120 by brazing, soldering, welding or other suitable method.

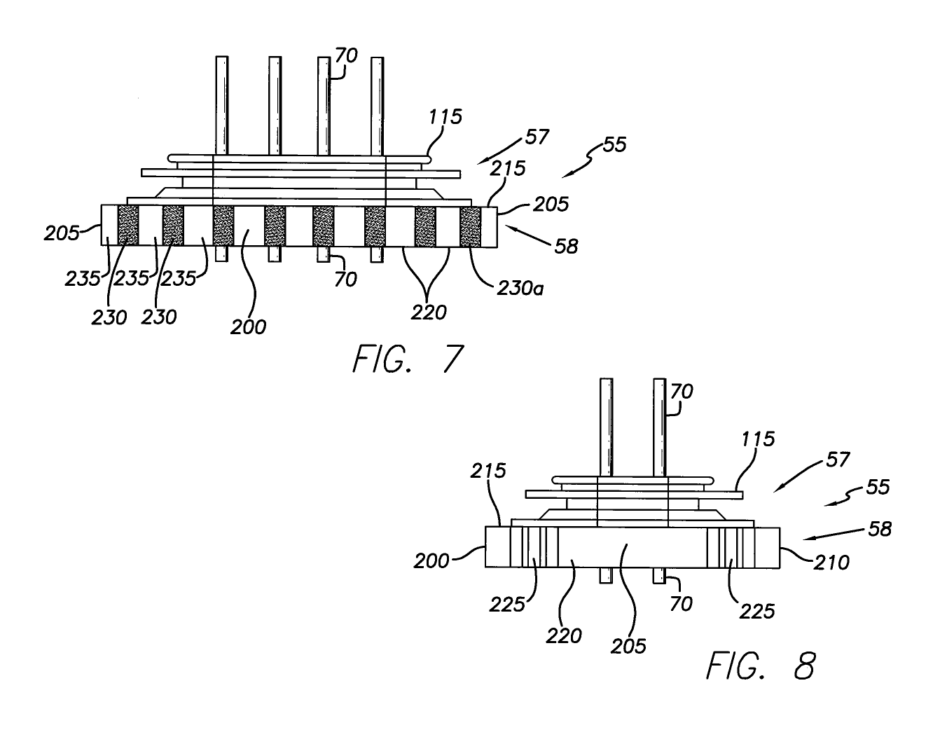

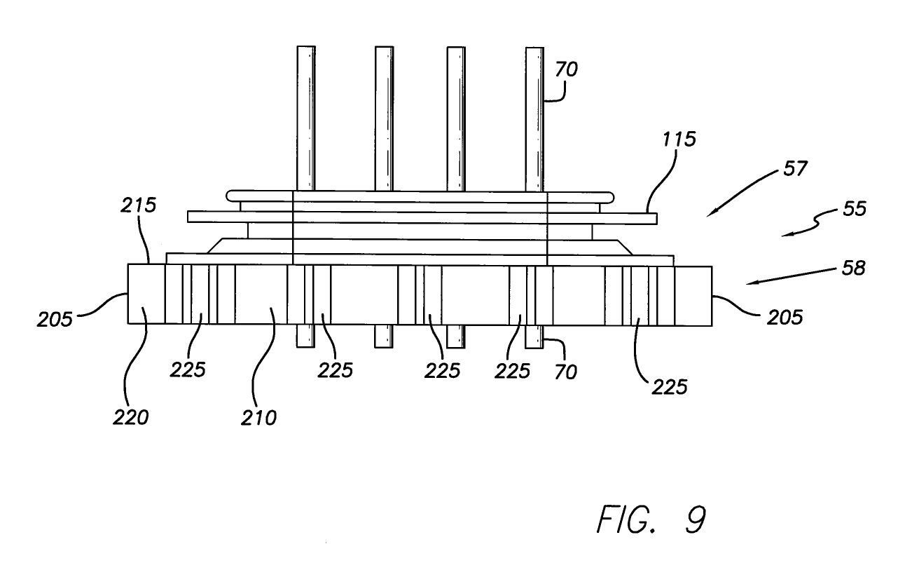

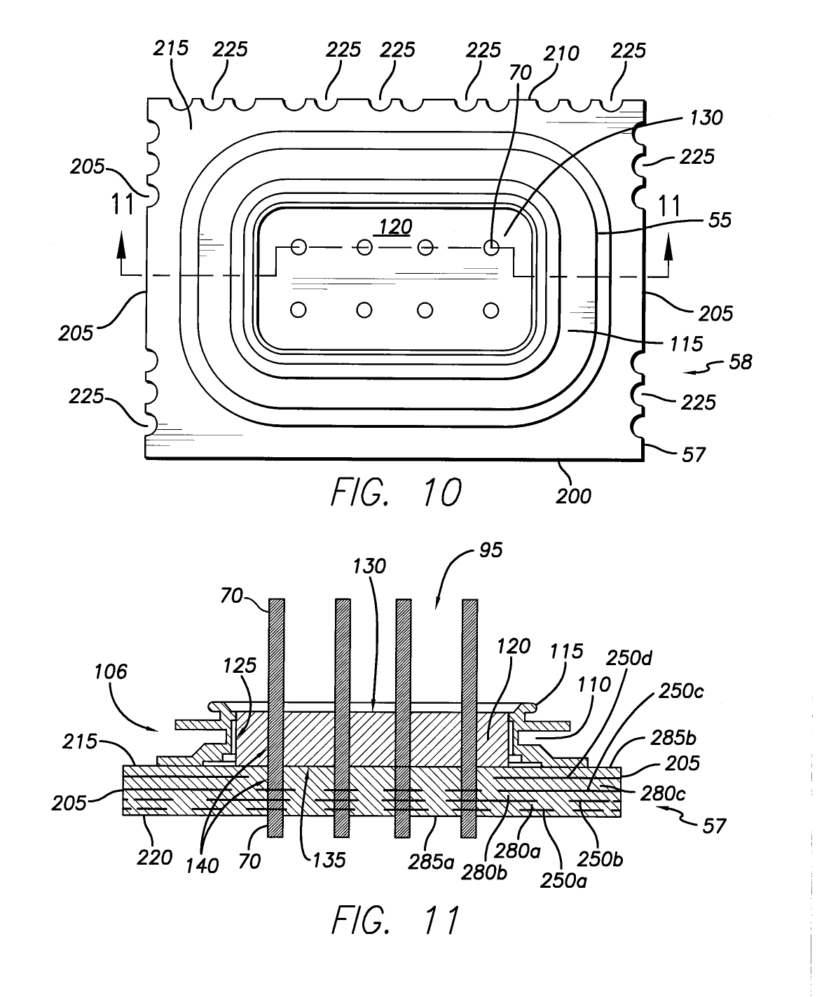

For a discussion regarding the feedthru assembly 55 including the feedthru 57 and integrated interconnect/filter feedthru substrate 58, reference is made to FIGS. 6-12. FIGS. 6 and 12 are, respectively, top side and bottom side isometric views of the feedthru assembly 55 shown in FIG. 1. FIGS. 7-10 are, respectively, a side view of the contact side of the feedthru assembly 55, an end view of the feedthru assembly 55, a side view the non-contact side of the feedthru assembly 55 opposite the contact side depicted in FIG. 7, and a top plan view of the feedthru assembly 55. FIG. 11 is a cross-section side view of the feedthru assembly 55 as taken along section line 11-11 in FIG. 10.

As shown in FIGS. 6-11, the integrated interconnect/filter feedthru substrate 58 may be configured for eight feedthru wires 70 and may be generally rectangular in shape to allow the feedthru substrate 58 to fit within the width of the can 15. The feedthru substrate 58 includes a contact face 200, opposed end faces 205 adjacent the contact face 200, a non-contact face 210 opposite the contact face 200, an upper face 215, and a bottom face 220 opposite the upper face 215. In one embodiment, the surfaces of the non-contact face 210 and end faces 205 are generally non-electrically conductive, except in electrically conductive vias 225 defined in the surfaces of the faces 210, 205. The surfaces of the vias 225 are coated with an electrically conductive material, such as gold, nickel, platinum, etc., where such coating is provided via electroplating, photo deposition, vapor deposition, etc. As discussed below, the vias 225 are used to electrically couple together the capacitance layers 250B-C of the filter aspect of the feedthru substrate 58.

As shown in FIGS. 6, 7 and 12, the contact face 200 include electrically conductive surfaces or pads 230 physically and electrically separated from each other in a spaced-apart fashion by electrically insulating surfaces 235. The surfaces of the electrically conductive surfaces 230 are coated with an electrically conductive material, such as gold, nickel, platinum, etc., where such coating is provided via electroplating, photo deposition, vapor deposition, etc. As can be understood from FIGS. 1 and 6, in one embodiment, the two substrates 17, 58 extend relatively perpendicular to each other, but have electrically conductive surfaces 235, 300 that are generally parallel or even coplanar with each other.

As indicated in FIG. 1, the electrically conductive surfaces 230 are connected to corresponding electrically conductive surfaces or pads 300 of the electronic substrate 17 via wire bonding 62. Wire bonding is advantageous. For example, wire bonding allows the electrically conductive surfaces 230 of the feedthru substrate 57 to be located in closer proximity to the electrically conductive surfaces 300 of the electronic substrate 17 than would otherwise be possible via wires, flex cable or other types of conductors; this advantage facilitates space savings for the pulse generator 5.

In one embodiment, the electronic substrate 17 and the feedthru substrate 58 are generally rigidly supported or mounted in the can 15 to prevent displacement or flex between the two substrates 17, 58. Such a rigid supporting or mounting within the can 15 for the two substrates 17, 58 facilitates the wire bonding 62 to extend between the electrically conductive surfaces 235, 300 without being subject to failure due to flexing.

As illustrated in FIGS. 6-9 and 11, the feedthru 57 is mounted on the feedthru substrate 58 such that the can side 100 of the feedthru 57 and the can face 135 of the core 120 abut against the upper face 215 of the feedthru substrate 58. The feedthru wires 70 extend into the holes 140 in the feedthru substrate 58. In some embodiments, the feedthru wires 70 extend through the feedthru substrate 58 to at least partially protrude from the bottom face 220 of the feedthru substrate 58, as indicated in FIG. 12.

As indicated in FIG. 12, the bottom face 220 includes power traces 240 that extend along the surface of the bottom face 220 from respective electrically conductive surfaces or pads 230 on the contact face 200 to respective feedthru wires 70 protruding from the bottom face 220. Thus, as can be understood from FIGS. 1, 11 and 12, a power or input circuit extending from the electronic substrate 17 (and its electronic components 71) housed in the can 15 to the lead connector blocks 20 in the header 25 extends from the electrically conductive pads 300 of the electronic substrate 17 to the electrically conductive surfaces or pads 230 of the feedthru substrate 58 via the wire bonds 62, from the electrically conductive surfaces 230 to the feedthru wires 70 via the power traces 240, and from the feedthru traces 70 to the lead connector blocks 20 via the conductors 60. The power traces 240 are electrically conductive material, such as gold, nickel, platinum, etc., coated on the surface of the bottom face 220 via electroplating, photo deposition, vapor deposition, etc. The surface of the bottom face 220 is be electrically insulating and, since the power traces 240 are spaced-apart from each other, the exposed regions of the surface of the bottom face 220 electrically isolate the power traces 240 from each other. The power traces 240 may exist as a power trace layer 250A of the substrate 58.

As can be understood from FIG. 12 and FIG. 13, which is the same view as FIG. 12, except the feedthru substrate 58 has been exploded and moved away from the feedthru 57 to show the various conductive, capacitive and shielding layers 250A-D of the feedthru substrate 58, a power trace 240a may actually extend along the perimeter of the bottom face 220 of the substrate 58. As shown in FIG. 12, this perimeter power trace 240a may not extend to any feedthru wire 70, but may instead electrically connect a specific electrically conductive surface or pad 230a on the contact face 200 to the various electrically conductive vias 225 extending vertically along the non-contact face 210 and the ends 205 of the feedthru substrate 58. As shown in FIG. 13, a shield layer 250D, which may form the surface of the upper face 215 of the feedthru substrate 58, is in electrical contact with both the vias 225 and the feedthru housing 115 of the feedthru 57, forming part of a ground circuit extending from the can wall 65, through the feedthru housing 115, the shield layer 250D, the vias 225, the specific perimeter power trace 240a, the specific electrically conductive surface 230a, and the wire bond 62 (see FIG. 1) to a ground portion (i.e., a specific electrically conductive pad) of the electronic substrate 17. The shield layer 250D is formed of an electrically conductive material, such as gold, nickel, platinum, etc., where such material is in the form of a unitary solid plate laid between the feedthru 57 and the feedthru substrate 58 or in the form of a coating provided on the surface of the upper face 215 of the feedthru substrate 58 via electroplating, photo deposition, vapor deposition, etc.

As can be understood from FIG. 13, the edge 255 of the shield layer 250D that is adjacent to the contact face 200 of the feedthru substrate 58 is recessed or offset inward towards the center of the shield layer 250D. As a result, the shield layer 250D is physically and electrically isolated from the electrically conductive surfaces 230 of the contact face 200. An opening 260 is defined in the center of the shield layer 250D such that none of the feedthru wires 70 physically or electrically contact the shield layer 250D. In one embodiment, all of the surface of the upper face 215 not formed by the shield layer 250D (e.g., those areas within the opening 260 and between the edge 255 and the contact face 200) are formed by electrically insulating material of the feedthru substrate 58.

Reference is now made to FIG. 13 and FIG. 14. FIG. 14 is the same view as FIG. 13, less the power trace layer 250A and shield layer 250D and wherein the capacitance layers 250B-C are less spread out in their expanded state to depict the feedthru wires 70 extending through the layers 250B-B-C. As can be understood from FIGS. 13 and 14, the feedthru substrate 58 includes upper and lower capacitance layer 250B-C sandwiched between the power trace layer 250A and the shield layer 250D. While two capacitance layers 250B-C are depicted in FIGS. 13 and 14, in other embodiments, there may be more than two such capacitance layers.

As can be understood from FIGS. 13 and 14, each capacitance layer 250B-C includes capacitance traces 270. In one embodiment, the capacitance traces 270 of the lower capacitance layer 250B extend from, and are electrically connected to, the feedthru wires 70, but not the electrically conductive vias 225. However, the capacitance traces 270 of the upper capacitance layer 250C extend from, and are electrically connected to, the electrically conductive vias 225, but not the feedthru wires 70. Thus, the lower capacitance layer 250B is directly electrically connected to the feedthru wires 70 and the rest of the power circuit, and the upper capacitance layer 250C is directly electrically connected to the vias 225 and the rest of the ground circuit.

As can be understood from FIGS. 13 and 14, each capacitance layer trace 270 for each feedthru wire 70 may have a different or same configuration as compared to any of the other capacitance layer traces 270 corresponding to the other feedthru wires 70. Thus, in some embodiments, the capacitance for each feedthru wire 70 may be caused to be the same as the capacitances of the rest of the feedthru wires 70. Alternatively, in other embodiments, the capacitances of the various feedthru wires 70 may be caused to be individual and unique from the capacitances of all other feedthru wires 70. In yet other embodiments, the capacitances for some feedthru wires 70 will be the same while the capacitances for other feedthru wires 70 may be different.

As best depicted in FIG. 13, the upper capacitance layer 250C may include electrically conductive donut traces 275 that are adjacent to, but physically offset from and electrically isolated from, the capacitance traces 270 of the upper capacitance layer 250C. The feedthru wires 70 extend through, and electrically connect to the donut traces 275.

As illustrated in FIG. 13, electrically insulating planar layers 280A-C (shown in via phantom lines) extend between the adjacent layers 250A-D to electrically isolate the adjacent layers 250A-D from each other. The capacitance layers 250B-C are formed of an electrically conductive material, such as gold, nickel, platinum, etc. Such electrically conductive materials for the capacitance layers 250B-C may be in the form of a unitary solid plate laid between the dielectric or insulation layers 280A-C or in the form of a coating provided the surfaces of the insulation layers 280A-C via electroplating, photo deposition, vapor deposition, etc. The capacitance layers 250B-C and associated insulation layers 280A-C may form an EMI filter 400. In some embodiments, the feedthru substrate 58 may include other passive components to achieve a desired filter characteristic.

Similarly, the power trace layer 250A and/or the shield layer 250D are formed of an electrically conductive material, such as gold, nickel, platinum, etc. Such electrically conductive materials for the power trace layer 250A and/or the shield layer 250D may be in the form of a unitary solid plate laid respectively laid on a surface of the dielectric or insulation layers 280A, 280C or in the form of a coating respectively provided on a surface of the insulation layers 280A, 280C via electroplating, photo deposition, vapor deposition, etc.

While the power trace layer 250A and the shield layer 250D are depicted in FIGS. 13 and 14 as being at or forming the respective surfaces of the bottom face 220 and top face 215 of the feedthru substrate 58, as indicated in FIG. 11 and in other embodiments, the power trace layer 250A and shield layer 250D may be imbedded in the feedthru substrate 58 such that electrically insulating surfaces 285A-B form the respective surfaces of the bottom face 220 and top face 215 of the feedthru substrate 58. In such an embodiment, the electrically conductive material forming the vias 225 extends across the top face 215 of the feedthru substrate 58 to place the vias 225 in electrical communication with the feedthru housing 115.

As can be understood from the preceding discussion, in one embodiment, the integrated feedthru/interconnect/filter assembly 55 disclosed herein includes a non-EMI filtered feedthru 57 close-coupled to an interconnect/filter feedthru substrate 58 having integrated filtering layers 250B-C that form the EMI filter 400 (see FIGS. 13 and 14). For example, in addition to including electrically conductive layers 250A and 250D within the feedthru substrate 58 for coupling the power and ground circuits of the feedthru assembly 55 to the electronic substrate 17 in the can 15, the feedthru substrate 58 also may include capacitance layers 250B-C and insulation layers 280A-C for creating the EMI filter 400.

In the context of this Detailed Discussion, a non-EMI filtered feedthru 57 means a standard feedthru 57 that does not have an integral EMI filter located within its feedthru housing 115 or forming all or part of its core 120. For example, the non-EMI filtered feedthru 57 does not include a discoidal EMI filter or other type of EMI filter forming all or part of the core 120 of the feedthru 57. Instead, the feedthru 57, which has no integral EMI filter capability of its own, is close-coupled with a interconnect/filter feedthru substrate 58 to form the EMI filtered feedthru assembly 55, the EMI filter capability of the feedthru assembly 55 being integral to the interconnect/filter feedthru substrate 58. As a result, the non-EMI filtered feedthru 57 is less expensive and more readily available as compared to, for example, a EMI filtered feedthru having an integral discoidal filter.

In other embodiments, the feedthru assembly 55 may employ an EMI filtered feedthru 57 (e.g., a feedthru 57 having an integral discoidal filter housed within its housing or forming at least a part of the feedthru core 120) close coupled to the feedthru substrate 58. In such an embodiment, the feedthru substrate 58 may provide additional EMI filtration or no additional EMI filtration, instead simply serving as a connection point for wire bond 62.

As illustrated in FIG. 1, due to the configuration of the interconnect substrate 58, the electrical contact surfaces 230 of the interconnect substrate 58 are located in a convenient location for electrically connecting via wire bond 62 to the corresponding electrical contact surfaces 300 of the electronic substrate 17. At least partially as a result of the convenient location of the electrical contact surfaces 230 of the feedthru substrate 58, wire bonding is made possible and space requirements within the can 15 are minimized. In one embodiment, the integrated interconnect/filter feedthru substrate 58 is made possible via integrated passive component (“IPC”) technology. Specifically, the integrated feedthru substrate 58 may be formed of laminates of dielectric 280A-C and conductors 250B-C to create parallel capacitance plates 250B-C and further including power or input traces 250A and side connections 230 to allow for wire bonding to the corresponding pads 300 of the electronics substrate and the establishment of an input circuit leading through the feedthru substrate 58 to the feedthru wires 70.

The resulting integrated feedthru/interconnect/filter assembly 55 advantageously provides a configuration that offers reduced size and materials cost. The resulting assembly also provides improved ease of manufacturing via automation, including the use of wire bond. These benefits facilitate a more compact pulse generator and decreased manufacturing costs.

Although the present invention has been described with reference to preferred embodiments, persons skilled in the art will recognize that changes may be made in form and detail without departing from the spirit and scope of the invention.

What is claimed is:

1. An implantable pulse generator comprising:
a header including a lead connector block;
a can coupled to the header and including a wall and an electronic substrate housed within the wall, the electronic substrate including an electrically conductive surface;
a feedthru mounted in the wall and including a header side, a can side and a feedthru wire extending through the feedthru and having a first end and a second end opposite the first end, the first end electrically coupled to the lead connector block;
a feedthru substrate adjacent the can side and including capacitance layers, an electrically conductive input layer, and an electrically conductive input surface defined on a surface of the feedthru substrate and electrically coupled to the input layer, the input layer electrically coupled to the second end; and
a wire bond electrically coupling the input surface to the electrically conductive surface of the electronic substrate.

2. The pulse generator of claim 1, wherein the capacitance layers includes electrically conductive layers separated by dielectric layers.

3. The pulse generator of claim 1, wherein the input layer includes at least one trace.

4. The pulse generator of claim 1, wherein the surface of the feedthru substrate on which the electrically conductive input surface is defined is on a side of the feedthru substrate that is at least one of generally lateral or generally perpendicular to the can side.

5. The pulse generator of claim 1, wherein the feedthru substrate further includes a shield layer.

6. The pulse generator of claim 1, wherein the input surface and the electrically conductive surface of the electronic substrate are generally parallel to each other.

7. An implantable pulse generator comprising:
a can including a wall;
a header coupled to the can and including at least one lead connector block;
an electronic substrate including an electrically conductive pad and at least one electronic component, the electronic substrate housed within the wall and the electrically conductive pad electrically coupled to a wire bond;
a feedthru mounted in the wall and including a header side, a can side, and at least one feedthru wire extending through the feedthru, each of the at least one feedthru wire including a header end and a can end, the header end electrically coupled to the at least one lead connector block; and
a feedthru substrate adjacent the can side, the feedthru substrate providing capacitance means for providing capacitance for the at least one feedthru wire and conductive means for electrically coupling the at least one feedthru wire to the wire bond.

8. The pulse generator of claim 7, wherein the electrically conductive pad includes a surface and the conductive means includes an electrically conductive surface generally parallel to the surface of the electrically conductive pad.

9. The pulse generator of claim 7, wherein the feedthru substrate includes a shield.

10. The pulse generator of claim 7, wherein the at least one feedthru wire includes two feedthru wires and the capacitance means provides different capacitance for the two feedthru wires.

11. The pulse generator of claim 7, wherein the capacitance means includes a plurality of electrically conductive layers and dielectric layers, and the conductive means includes an electrically conductive layer and an electrically conductive surface, the electrically conductive layer extending between the can end and the conductive surface.

12. A feedthru assembly for being mounted in a can wall of an implantable pulse generator having a can and a header, the feedthru assembly comprising:
a feedthru including a housing, an electrically insulating body, and a feedthru wire, the housing configured to mount in the can wall and including an opening defined in the housing, the electrical insulating body being received in the opening and including a header side and a can side, the feedthru wire extending through the electrically insulating body from the header side to the can side; and
a feedthru substrate adjacent the can side and having multiple layers, at least some of the multiple layers being electrically conductive capacitance layers and at least one of the multiple layers being an electrically conductive input layer electrically coupled to the feedthru wire.

13. The feedthru assembly of claim 12, wherein at least one of the multiple layers includes a trace.

14. The feedthru assembly of claim 12, further comprising an electrically conductive input surface defined on a surface of the feedthru substrate, the electrically conductive input surface being electrically coupled to the input layer.

15. The feedthru assembly of claim 14, wherein the input surface is generally parallel to a longitudinal length of the feedthru wire in a region of the feedthru wire extending through the insulating body.

16. The feedthru assembly of claim 12, wherein the surface of the feedthru substrate on which the electrically conductive input surface is defined is on a side of the feedthru substrate that is at least one of generally lateral or generally perpendicular to the can side.

17. The feedthru assembly of claim 12, wherein the electrically conductive input layer is defined on a bottom surface of the feedthru substrate.

18. The feedthru assembly of claim 17, wherein the feedthru wire extends through the substrate to at least the bottom surface.

19. The feedthru assembly of claim 17, wherein at least one of the multiple layers is a shield layer electrically coupled to the housing.
